(19) United States
(12) Patent Application Publication
(10) Pub. No.: US 2003/0077113 A1
(43) Pub. Date: Apr. 24, 2003

(54) Threaded fastener and a connector having the threaded fastener

(76) Inventors: Masaru Fukuda, Shizuoka (JP); Yoshiro Kakuda, Aichi (JP); Tohru Takaki, Aichi (JP); Motohiro Takatsuka, Shizuoka (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/253,908

(22) Filed: Sep. 25, 2002

(30) Foreign Application Priority Data
Sep. 28, 2001 (JP) 2001-302473

(51) Int. Cl. F16D 1/12

(52) U.S. Cl. 403/122

(57) ABSTRACT

A threaded fastener and a connector having the threaded fastener are provided, which threaded fastener includes: a shank, with a screw thread thereon, to be screwed to a mating member; and a head continuing from the shank and having a regular-polygonal cross section, wherein the head has an expanding portion with a cross-sectional area gradually becoming larger toward the shank and a reducing portion with a cross-sectional area gradually becoming smaller toward the shank, the reducing portion continues from the expanding portion in a direction of an axis of the shank, and the reducing portion is arranged nearer the shank than the expanding portion.

### BACKGROUND OF THE INVENTION

1. Field of the Invention

The present invention relates to a threaded fastener screwed to a mating member and a connector having the threaded fastener.

2. Description of the Related Art

A motor vehicle is equipped with a meter apparatus 100 (FIG. 18) in order to show a driver various information. The meter apparatus 100 is attached to a frame 102 positioned behind the instrument panel 101 as shown in FIG. 18.

A connector 105 is used in order to supply electric power from power and transmit various signal to the meter apparatus 100. The connector 105 has a male connector housing 106 attached to the frame 102, a female connector housing 108 having a hole 107 and coupled with the male connector housing 106, a nut 109 as a mating member attached to the male connector housing 106, and a bolt 103 (FIG. 17) with a general hexagon head, which bolt 103 passes through the hole 107 of the female connector housing 108.

By screwing the bolt 103 to the nut 109, the female connector housing 108 couples with the male connector housing 106. A terminal metal fitting in the male connector housing 106 is securely electrically connected to a terminal metal fitting in the female connector housing 108.

A gap between the instrument panel 101 and the meter apparatus 100 is minimized for good appearance.

With respect to the above prior art, however, a space for arranging the bolt 103 to fix the female connector housing 108 to the male connector housing 106 is very narrow because of the minimized gap between the instrument panel 101 and the meter apparatus 100. Therefore, as shown in FIG. 18, an axis R1 of the socket wrench 104 to turn the bolt 103 and an axis P1 of the bolt 103 are not aligned. Therefore, it is difficult to turn the bolt 103.

### SUMMARY OF THE INVENTION

In view of the foregoing, an object of the present invention is to provide a threaded fastener which can be securely screwed to a mating member in a narrow space and a connector having the threaded fastener, wherein connector housings of the connector are securely coupled in a narrow space.

In order to achieve the above object, as a first aspect of the present invention, based on the first aspect, a threaded fastener comprises: a shank, with a screw thread thereon, to be screwed to a mating member; and a head continuing from the shank and having a regular-polygonal cross section, wherein the head has an expanding portion with a cross-sectional area gradually becoming larger toward the shank and a reducing portion with a cross-sectional area gradually becoming smaller toward the shank, the reducing portion continues from the expanding portion in a direction of an axis of the shank, and the reducing portion is arranged nearer the shank than the expanding portion.

As a second aspect of the present invention, a threaded fastener comprises: a shank, with a screw thread thereon, to be screwed to a mating member; and a head continuing from the shank and having a regular-polygonal cross section, wherein the head has an expanding portion with a cross-sectional area gradually becoming larger toward the shank, and an end portion, positioned nearer the shank, of the expanding portion has a periphery larger than a periphery of the shank.

As a third aspect of the present invention, based on the first or second aspect, the expanding portion has convex surfaces.

As a fourth aspect of the present invention, based on the first aspect, the reducing portion has convex surfaces.

As a fifth aspect of the present invention, based on the first or second aspect, the expanding portion has flat planes.

As a sixth aspect of the present invention, based on the first aspect, the reducing portion has flat planes.

As a seventh aspect of the present invention, a connector comprises: a first connector housing; a second connector housing coupling with the first connector housing; a nut attached to one of the first and second connector housings; a hole bored through the other of the first and second connector housings and aligned with the nut when the first and the second connector housings are coupled with each is other; and a threaded fastener put through the hole and screwed to the nut, wherein the threaded fastener comprises: a shank, with a screw thread thereon, to be screwed to a mating member; and a head continuing from the shank and having a regular-polygonal cross section, and wherein the head has an expanding portion with a cross-sectional area gradually becoming larger toward the shank and a reducing portion with a cross-sectional area gradually becoming smaller toward the shank, the reducing portion continues from the expanding portion in a direction of an axis of the shank, and the reducing portion is arranged nearer the shank than the expanding portion.

As an eighth aspect of the present invention, a connector comprises: a first connector housing; a second connector housing coupling with the first connector housing; a nut attached to one of the first and second connector housings; a hole bored through the other of the first and second connector housings and aligned with the nut when the first and the second connector housings are coupled with each other; and a threaded fastener put through the hole and screwed to the nut, wherein the threaded fastener comprises: a shank, with a screw thread thereon, to be screwed to a mating member; and a head continuing from the shank and having a regular-polygonal cross section, and wherein the head has an expanding portion with a cross-sectional area gradually becoming larger toward the shank, and an end portion, positioned nearer the shank, of the expanding portion has a periphery larger than a periphery of the shank.

As a ninth aspect of the present invention, based on the seventh or eighth aspect, the expanding portion has convex surfaces.

As a tenth aspect of the present invention, based on the seventh aspect, the reducing portion has convex surfaces.

As an eleventh aspect of the present invention, based on the seventh or eighth aspect, the expanding portion has flat planes.

As a twelfth aspect of the present invention, based on the seventh aspect, the reducing portion has flat planes.

According to the above-described structures of the present invention, the following advantages are provided.

(1) According to the first aspect of the present invention, the head of the threaded fastener has the expanding portion and the reducing portion and the reducing portion is arranged nearer the shank than the expanding portion. Therefore, the head can sufficiently enter the working portion of the socket wrench in a state that the axis of the wrench is inclined with respect to the shank of the threaded fastener. Therefore, the inventive threaded fastener can be securely screwed to the mating member in a narrow space.

(2) According to the second aspect of the present invention, the head of the threaded fastener has the expanding portion. Therefore, the head can sufficiently enter the working portion of the socket wrench in a state that the axis of the wrench is inclined with respect to the shank of the threaded fastener. Therefore, the inventive threaded fastener can be securely screwed to the mating member in a narrow space.

(3) According to the third aspect of the present invention, the outside surface of the expanding portion has convex surfaces. Therefore, the head can sufficiently enter the working portion of the socket wrench in a state that the axis of the wrench is inclined with respect to the shank of the threaded fastener. Therefore, the inventive threaded fastener can be securely screwed to the mating member in a narrow space.

(4) According to the fourth aspect of the present invention, the outside surface of the reducing portion has convex surfaces. Therefore, the head can sufficiently enter the working portion of the socket wrench in a state that the axis of the wrench is inclined with respect to the shank of the threaded fastener. Therefore, the inventive threaded fastener can be securely screwed to the mating member in a narrow space.

(5) According to the fifth aspect of the present invention, the outside surface of the expanding portion has flat planes. Therefore, the head can sufficiently enter the working portion of the socket wrench in a state that the axis of the wrench is inclined with respect to the shank of the threaded fastener. Therefore, the inventive threaded fastener can be securely screwed to the mating member in a narrow space.

(6) According to the sixth aspect of the present invention, the outside surface of the reducing portion has flat planes. Therefore, the head can sufficiently enter the working portion of the socket wrench in a state that the axis of the wrench is inclined with respect to the shank of the threaded fastener. Therefore, the inventive threaded fastener can be securely screwed to the mating member in a narrow space.

(7) According to the seventh aspect of the present invention, the head of the threaded fastener has the expanding portion and the reducing portion, wherein a cross-sectional area (i.e. an area of a section orthogonally crossing to the axis of the threaded fastener) of the expanding portion gradually becomes larger toward the shank and a cross-sectional area of the reducing portion gradually becomes smaller toward the shank from the expanding portion. An outer surface of the reducing portion continues from that of the expanding portion.

Therefore, in the inventive connector, the head of the threaded fastener can sufficiently enter the working portion of the socket wrench in a state that the axis of the wrench is inclined with respect to the axis of the threaded fastener. Therefore, the threaded fastener can be securely screwed to the mating member in a narrow space, thereby securely coupling the connector housings.

(8) According to the eighth aspect of the present invention, the head of the threaded fastener has the expanding portion whose cross-sectional, area gradually becomes larger toward the shank. Therefore, in the inventive connector, the head of the threaded fastener can sufficiently enter the working portion of the socket wrench in a state that the axis of the wrench is inclined with respect to the axis of the threaded fastener. Therefore, the threaded fastener can be securely screwed to the mating member in a narrow space, thereby securely coupling the connector housings.

(9) According to the ninth aspect of the present invention, the outside surface of the expanding portion has convex surfaces. Therefore, the head can sufficiently enter the working portion of the socket wrench in a state that the axis of the wrench is inclined with respect to the shank of the threaded fastener. Therefore, the threaded fastener can be securely screwed to the mating member in a narrow space, thereby securely coupling the connector housings.

(10) According to the tenth aspect of the present invention, the outside surface of the reducing portion has convex surfaces. Therefore, the head can sufficiently enter the working portion of the socket wrench in a state that the axis of the wrench is inclined with respect to the shank of the threaded fastener. Therefore, the threaded fastener can be securely screwed to the mating member in a narrow space, thereby securely coupling the connector housings.

(11) According to the eleventh aspect of the present invention, the outside surface of the expanding portion has flat planes. Therefore, the head can sufficiently enter the working portion of the socket wrench in a state that the axis of the wrench is inclined with respect to the shank of the threaded fastener. Therefore, the threaded fastener can be securely screwed to the mating member in a narrow space, thereby securely coupling the connector housings.

(12) According to the twelfth aspect of the present invention, the outside surface of the reducing portion has flat planes,. Therefore, the head can sufficiently enter the working portion of the socket wrench in a state that the axis of the wrench is inclined with respect to the shank of the threaded fastener. Therefore, the threaded fastener can be securely screwed to the mating member in a narrow space, thereby securely coupling the connector housings.

The above and other objects and features of the present invention will become more apparent from the following description taken in conjunction with the accompanying drawings.

### BRIEF DESCRIPTION OF THE DRAWINGS

FIG. 1 is a perspective view showing a first embodiment of a bolt in accordance with the present invention.

FIG. 2 is a side view of the bolt shown in FIG. 1.

FIG. 3 is a plan view of a head of the bolt shown in FIG. 1.

FIG. 4 is an explanatory illustration showing a connector having the bolt shown in FIG. 1.

FIG. 5 is a sectional view taken along a line V-V in FIG. 4.

FIG. 6 is a sectional view showing a state that an engaging portion of a first frame of the connector shown in FIG. 5 engages a hole of a frame.

FIG. 7 is a sectional view showing a state that a second frame is provisionally attached to the first frame having been fixed to the frame.

FIG. 8 is a sectional view showing a state that a shank of the bolt is put through a hole provided on the second frame shown in FIG. 7.

FIG. 9 is a perspective view showing a second embodiment of a bolt in accordance with the present invention.

FIG. 10 is a side view of the bolt shown in FIG. 9.

FIG. 11 is a plan view of a head of the bolt shown in FIG. 9.

FIG. 12 is an explanatory illustration showing a connector having the bolt shown in FIG. 9.

FIG. 13 is a perspective view showing a third embodiment of a bolt in accordance with the present invention.

FIG. 14 is a side view of the bolt shown in FIG. 13.

FIG. 15 is a plan view of a head of the bolt shown in FIG. 13.

FIG. 16 is an explanatory illustration showing a connector having the bolt shown in FIG. 13.

FIG. 17 is a perspective view showing a prior art bolt.

FIG. 18 is an explanatory illustration showing a connector having the bolt shown in FIG. 17.

### DESCRIPTION OF THE PREFERRED EMBODIMENT(S)

Embodiment(s) of the present invention will now be described in further detail with reference to the accompanying drawings.

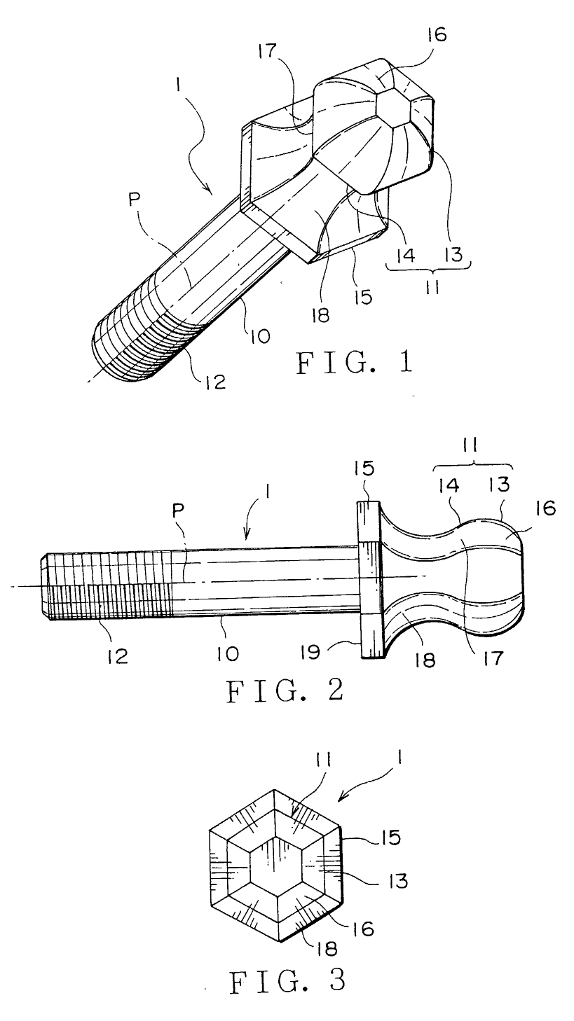

A first embodiment of the inventive bolt (threaded fastener) and connector having the bolt will be described with reference to FIGS. 1-8. The bolt 1 shown in is FIG. 1 is used for fixing a first connector housing 51 and a second connector housing 52 of a connector 50. The connector 50 supplies electric power and transmits various signals to a meter apparatus 2 fixed to a frame 3.

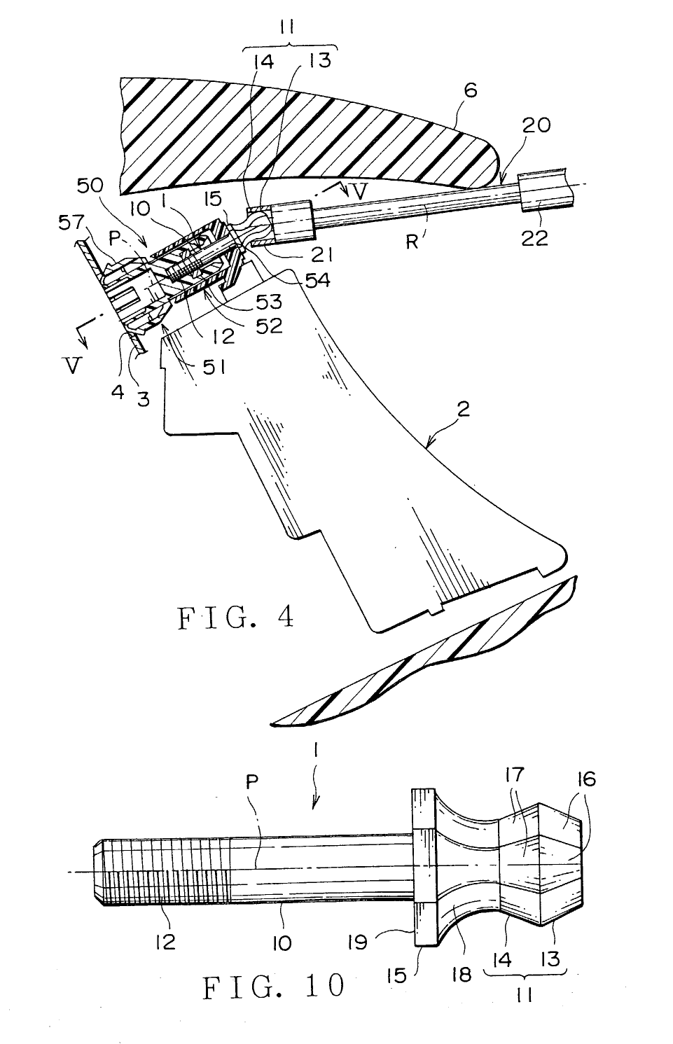

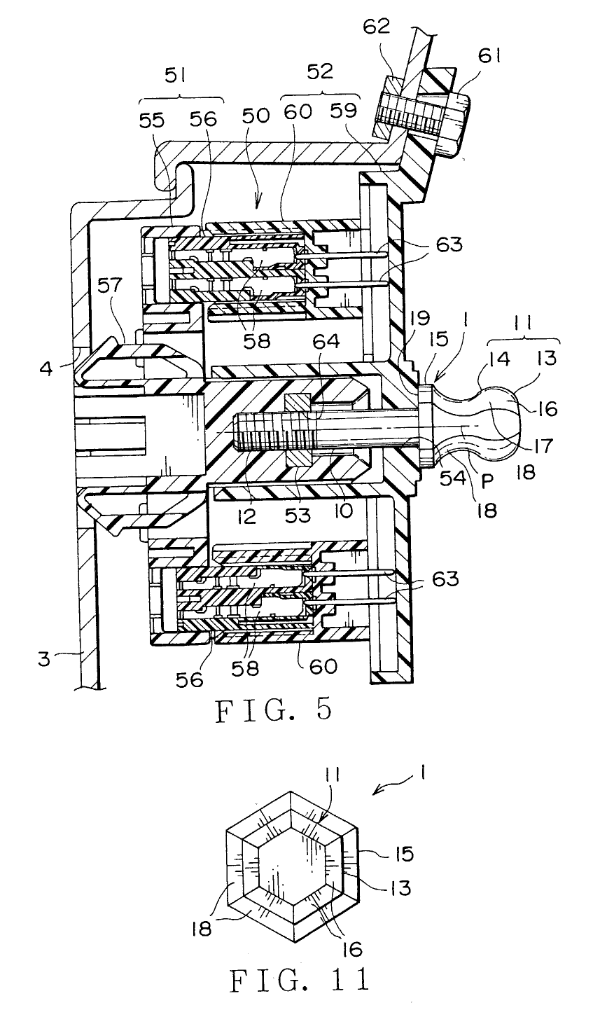

The meter apparatus 2 is installed on a motor vehicle. The meter apparatus 2 shows a driver of the motor vehicle various states of the motor vehicle, such as a speed of the motor vehicle, an engine rotation speed, a remaining quantity of the fuel and the temperature of the engine cooling water. The frame 3 is positioned behind the instrument panel 6. In the frame 3, a hole 4 is provided as shown in FIG. 4 and FIG. 5.

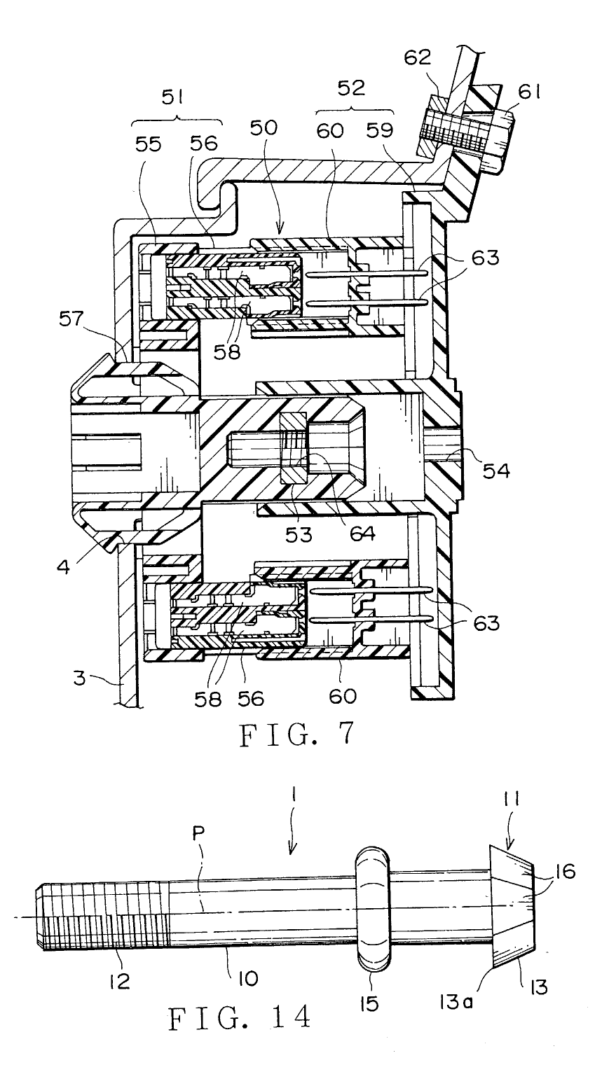

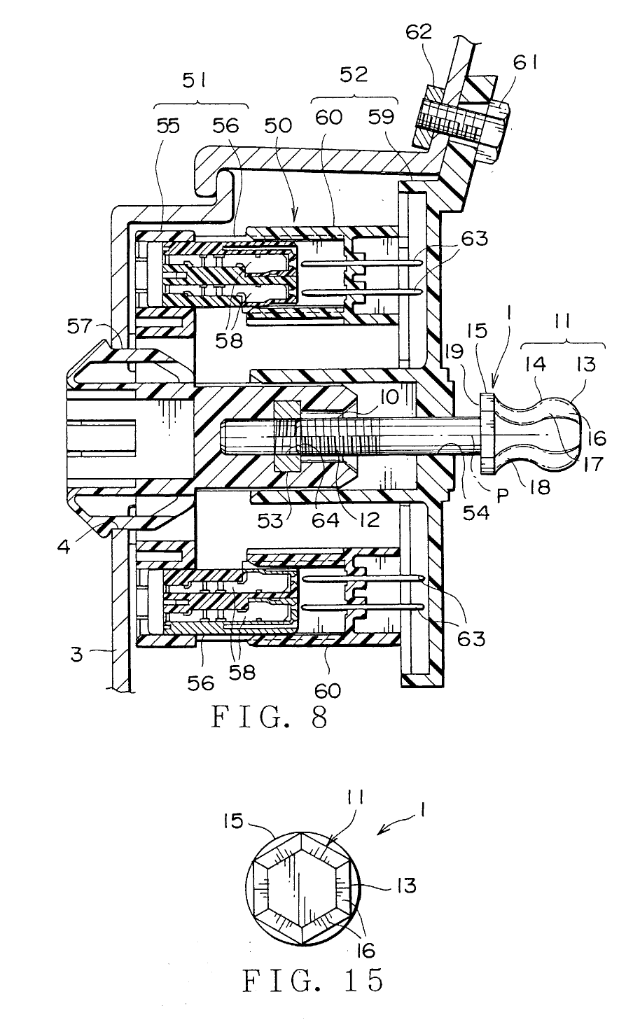

The connector 50 has the first connector housing 51, the second connector housing 52, a nut 53, a hole 54 and the above bolt 1 as shown in FIG. 5, FIG. 7 and FIG. 8. The first connector housing 51 has a first frame 55 and a plurality of male connector housings (hereinafter, male housings) 56 as shown in FIGS. 5-8.

The first frame 55 is molded of synthetic resin. The first frame 55 has an engaging portion 57 engage the hole 4 of the frame 3. The male housing 56 is attached to the first frame 55. The male housing 56 is formed in a box-shape. The male housing 56 accommodates a female terminal 58.

The second connector housing 52 has a second frame 59 and a plurality of female connector housings (hereinafter, female housings) 60 as shown in FIG. 5, FIG. 7 and FIG. 8. The second frame 59 is molded of synthetic resin. The second frame 59 is in a body with the meter apparatus 2. The second frame 59 is fixed to the frame 3 by the bolt 61 and the nut 62. The nut 62 is attached to the frame 3. The female housing 60 is attached to the second frame 59. The female housing 60 is formed cylindrically. The female housing 60 accommodates a male terminal 63.

The hole 54 of the second frame 59 and the screw hole 64 of the nut 53 are aligned in a line. The male housing 56 and the female housing 60 are coupled with each other.

The nut 53 is insert-molded in the first frame 55. That ism the nut 53 is embedded in the first connector housing 51. The hole 54 is bored through the second frame 59 of the second connector housing 52.

A shank 10 of the bolt 1 goes through the hole 54 and is screwed to the nut 53 (the mating member) so that the first frame 55 can be secured to the second frame 59 and the female housing 60 can be coupled to the male housing 56.

The bolt 1 has the shank 10, the head 11 and a flange portion 15 as shown in FIG. 1 and FIG. 2. A central axis (an axis) P of the shank 10 is a straight line. The screw thread 12 is formed on the outer surface of the shank 10.

The head 11 is provided on one end portion of the shank 10. The head 11 a regular-polygonal cross section as shown in FIG. 3. In the illustrated embodiment, the cross section of the head 11 is of a regular hexagon. The head 11 has an expanding portion 13 and a reducing portion 14 as shown in FIG. 2.

The reducing portion 14 is arranged nearer the shank 10 than the expanding portion 13. A cross-sectional area (i.e. an area of a section orthogonally crossing to the axis P) of the expanding portion 13 gradually becomes larger toward the shank. A cross-sectional area (i.e. an area of a section orthogonally crossing to the axis P) of the reducing portion 14 gradually becomes smaller toward the shank from the expanding portion 13. An outer surface of the reducing portion 14 continues from that of the expanding portion 13.

The flange portion 15 radially projects over the whole circumference of the shank 10. The flange portion 15 is provided adjacent to the reducing portion 14. The flange portion 15 has a regular-polygonal cross section (regular hexagon in the illustrated embodiment).

The expanding portion 13 and the reducing portion 14 have respective convex surfaces at general longitudinal (i.e. the axis P direction) centers of respective outside surfaces 16,17 as shown in FIG. 2. An outside surface 18 of the flange portion 15 has a concave surface adjacent to the reducing portion 14 as shown. The outside surfaces 16,17,18 continue smoothly.

When the connector 1 is assembled, that is, when the meter apparatus 2 is attached to the frame 3, first, the first connector housing 51 is assembled by mounting the male housing 56 on the first frame 55. And then, the second connector housing 52 is assembled by mounting the female housing 60 on the second frame 59.

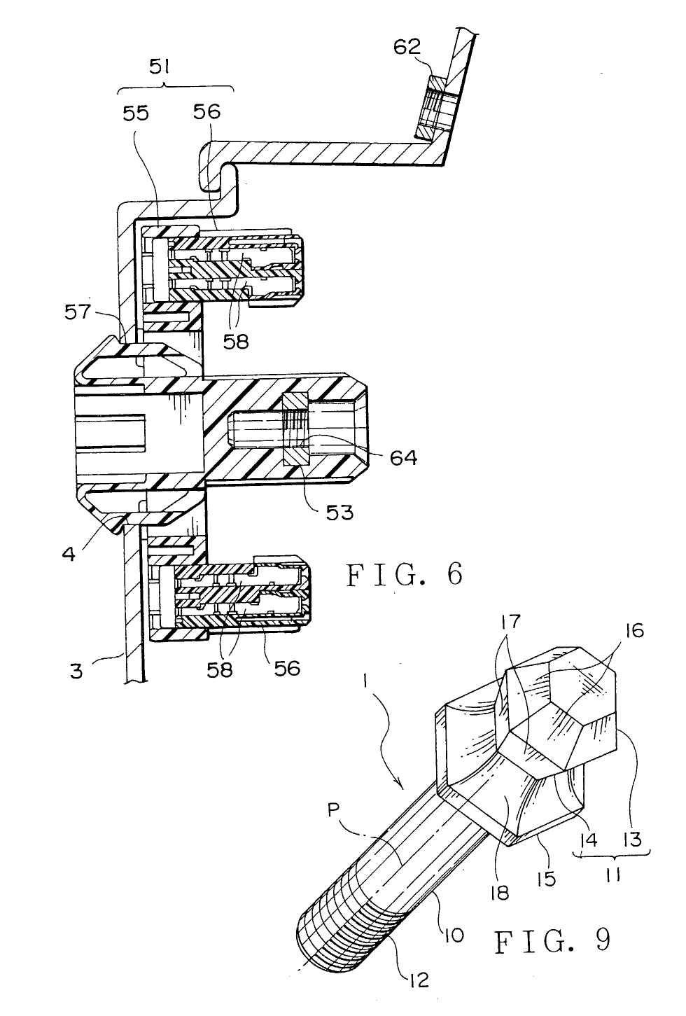

Subsequently, as shown in FIG. 6, the engaging portion 57 of the first frame 55 is engaged with the hole 4 of the frame 3. Following the above, as shown in FIG. 7, the second frame 59 is put on the first frame 55, and the second frame 59 is attached to the frame,3 by using the bolt 61 and the nut 62. At this time, a part of the male housing 56 has been inserted in the female housing 60, and the hole 54 and the screw hole 64 are aligned in a line.

As shown in FIG. 8, the shank 10 of the bolt 1 is put in the hole 54. The screw thread 12 of the shank 10 of the bolt 1 is screwed in the screw hole 64 of the nut 53. As shown in FIG. 4, a tubular working portion 21 of a socket wrench 20 is fit on the head 11, and the socket wrench 20 is turned or rotated around the axis R shown in FIG. 4.

Then, the above bolt 1 is rotated around the axis P and screwed in the screw hole 64 of the nut 53. By this, the engaging portion 57 goes through the hole 4 of the frame 3 gradually, while the female housing 60 couples with the male housing 56. Like this, the first frame 55 and the second frame 59 are secured to each other, and the male housing 56 and the female housing 60 are coupled with each other.

Here, the above socket wrench 20 has the straight axis R. The socket wrench 20 has a cylindrical handling portion 22 and the working portion 21 with a recess. The working portion 21 coaxially continues from the handling portion 22. The recess of the working portion 21 has a regular-polygonal (i.e. regular-hexagonal) cross section same as the head 11 of the bolt.

According to the present embodiment, because the expanding portion 13 and the reducing portion 14 have respective convex outside surfaces 16,17, the head 11 of the bolt can enter the working portion 21 of the socket wrench 20 in a state that the axis P of the bolt inclines with respect to the axis R of the wrench as shown in FIG. 4. All the six planes can make a surface contact with the corresponding inside planes of the working portion of the wrench. In this state, the socket wrench 20 can be rotated around the axis R.

The bolt 1 is rotated by the socket wrench 20 around the axis P. Like this, the bolt 1 can be securely screwed to the screw hole 64 of the nut 53 in a narrow space, thereby securely coupling the male housing 56 and the female housing 60 of the connector 50 even in a narrow space.

Next, a second embodiment of the inventive bolt 1 and connector 50 will be described with reference to FIGS. 9-12. Here, the same references are assigned to the same elements as those of the above-described first embodiment, and the description thereof is omitted. Also in the present embodiment, a cross section of the head 11 of the bolt 1 is regular-polygonal (illustrated in FIG. 9 is regular-hexagonal shape).

The outside surfaces 16,17 of the expanding portion 13 and the reducing portion 14, respectively, consists of flat planes as shown in FIG. 9 and FIG. 10. Each plane of the outside surfaces 16,17 are inclined with respect to the axis P.

Also in the present embodiment, a cross-sectional area (i.e. an area of a section orthogonally crossing to the axis P) of the expanding portion 13 gradually becomes larger toward the shank. A cross-sectional area of the reducing portion 14 gradually becomes smaller toward the shank from the expanding portion 13. An outer surface of the reducing portion 14 continues from that of the expanding portion 13. The reducing portion 14 is arranged nearer the shank 10 than the expanding portion 13.

According to the present embodiment, because the expanding portion 13 and the reducing portion 14 have respective inclined outside surfaces 16,17, the head 11 of the bolt can enter the working portion 21 of the socket wrench 20 in a state that the axis P of the bolt inclines with respect to the axis R of the wrench as shown in FIG. 12. All the six planes can make a surface or line contact with the corresponding inside planes of the working portion of the wrench. In this state, the socket wrench 20 can be rotated around the axis R.

The bolt 1 is rotated by the socket wrench 20 around the axis P. Like this, the bolt 1 can be securely screwed to the screw hole 64 of the nut 53 in a narrow space, thereby securely coupling the male housing 56 and the female housing 60 of the connector 50 even in a narrow space.

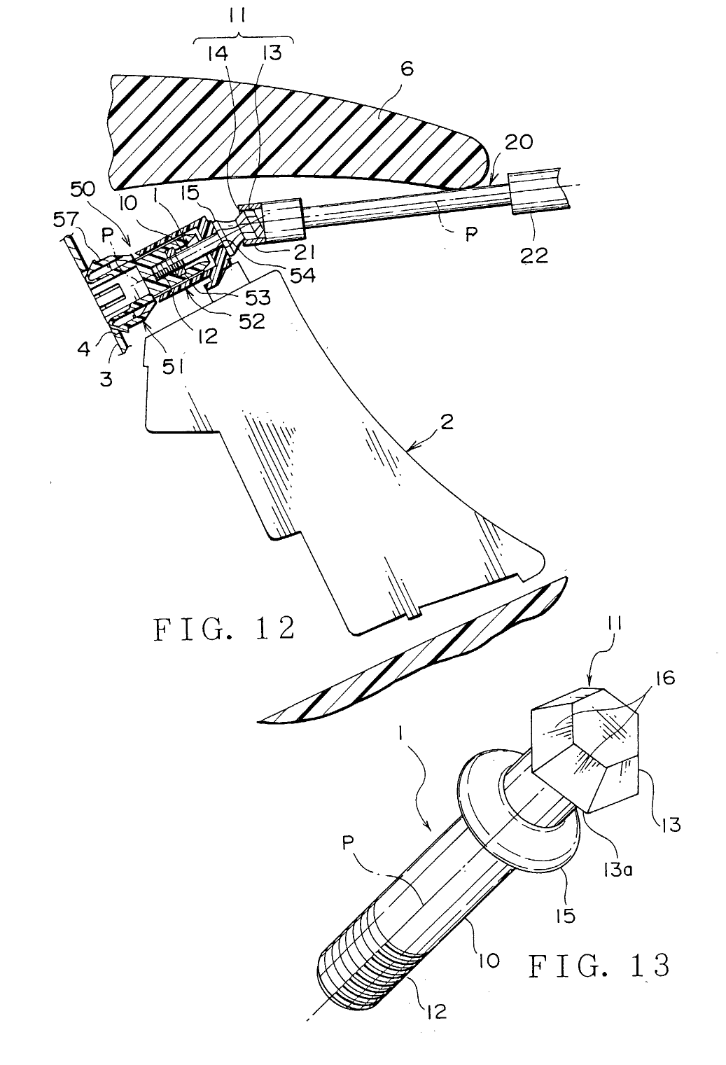

Next, a third embodiment of the inventive bolt 1 and connector 50 will be described with reference to FIGS. 13-16. Here, the same references are assigned to the same elements as those of the above-described first or second embodiment, and the description thereof is omitted. In the present embodiment, the head 11 of the bolt 1 has only the expanding portion 13 as shown in FIG. 13 and FIG. 14. An end portion 13a, nearer the shank 10, of the expanding portion 13 radially projects as shown in FIG. 13.

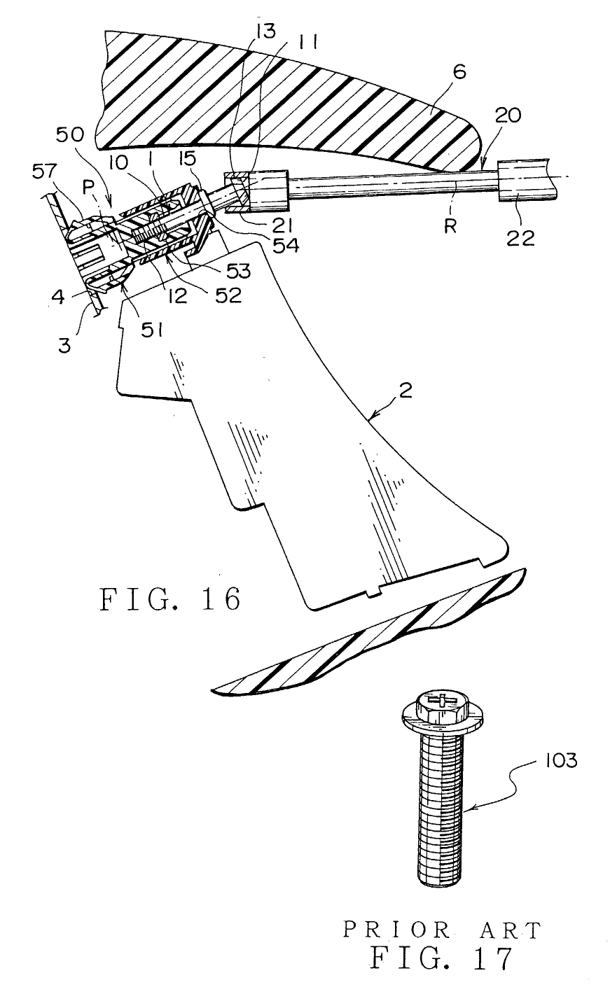

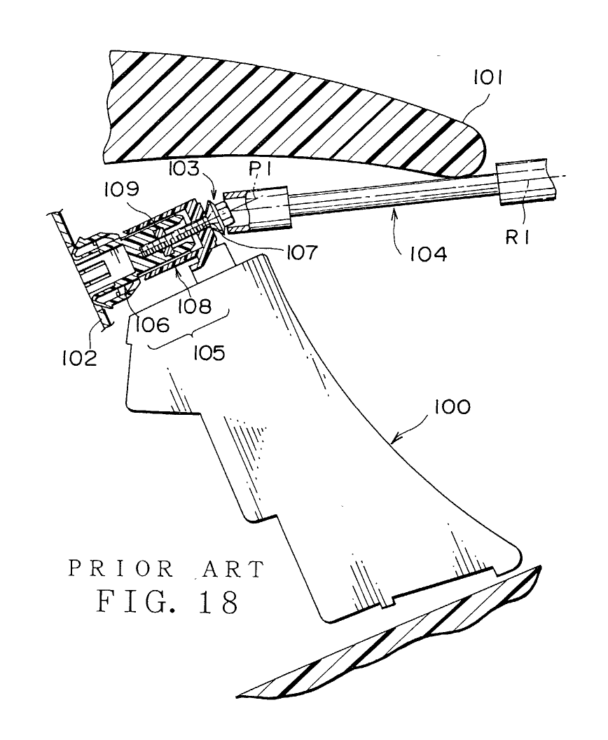

Also in the present embodiment, a cross section of the head 11 of the bolt 1 is regular-polygonal (illustrated in FIG. 15 is regular-hexagonal shape). The outside surface 16 of the expanding portion 13 consists of flat planes as shown in FIG. 13 and FIG. 14. Each plane of the outside surface 16 are inclined with respect to the axis P.

According to the present embodiment, because the expanding portion 13 has inclined outside surface 16, the head 11 of the bolt can enter the working portion 21 of the socket wrench 20 in a state that the axis P of the bolt inclines with respect to the axis R of the wrench as shown in FIG. 12. All the six planes can make a surface or line contact with the corresponding inside planes of the working portion of the wrench. In this state, the socket wrench 20 can be rotated around the axis R.

The bolt 1 is rotated by the socket wrench 20 around the axis P. Like this, the bolt 1 can be securely screwed to the screw hole 64 of the nut 53 in a narrow space, thereby securely coupling the male housing 56 and the female housing 60 of the connector 50 even in a narrow space.

In the above embodiments, the bolt (external thread) can be replaced with an internal thread, and the nut can be replace with an external thread.

Further, in the third embodiment, the flat planes of the head of the bolt can be replaced with convex surfaces.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A threaded fastener, comprising:
a shank, with a screw thread thereon, to be screwed to a mating member; and
a head continuing from the shank and having a regular-polygonal cross section,
wherein the head has an expanding portion with a cross-sectional area gradually becoming larger toward the shank and a reducing portion with a cross-sectional area gradually becoming smaller toward the shank,
the reducing portion continues from the expanding portion in a direction of an axis of the shank, and
the reducing portion is arranged nearer the shank than the expanding portion.

2. A threaded fastener, comprising:
a shank, with a screw thread thereon, to be screwed to a mating member; and
a head continuing from the shank and having a regular-polygonal cross section,
wherein the head has an expanding portion with a cross-sectional area gradually becoming larger toward the shank, and
an end portion, positioned nearer the shank, of the expanding portion has a periphery larger than a periphery of the shank.

3. The threaded fastener as set forth in claim 1 or claim 2, wherein
the expanding portion has convex surfaces.

4. The threaded fastener as set forth in claim 1, wherein
the reducing portion has convex surfaces.

5. The threaded fastener as set forth in claim 1 or claim 2, wherein
the expanding portion has flat planes.

6. The threaded fastener as set forth in claim 1, wherein
the reducing portion has flat planes.

7. A connector, comprising:
a first connector housing;
a second connector housing coupling with the first connector housing;
a nut attached to one of the first and second connector housings;
a hole bored through the other of the first and second connector housings and aligned with the nut when the first and the second connector housings are coupled with each other; and
a threaded fastener put through the hole and screwed to the nut,
wherein the threaded fastener comprises:
a shank, with a screw thread thereon, to be screwed to a mating member; and
a head continuing from the shank and having a regular-polygonal cross section, and
wherein the head has an expanding portion with a cross-sectional area gradually becoming larger toward the shank and a reducing portion with a cross-sectional area gradually becoming smaller toward the shank,
the reducing portion continues from the expanding portion in a direction of an axis of the shank, and
the reducing portion is arranged nearer the shank than the expanding portion.

8. A connector, comprising:
a first connector housing;
a second connector housing coupling with the first connector housing;
a nut attached to one of the first and second connector housings;
a hole bored through the other of the first and second connector housings and aligned with the nut when the first and the second connector housings are coupled with each other; and
a threaded fastener put through the hole and screwed to the nut,
wherein the threaded fastener comprises:
a shank, with a screw thread thereon, to be screwed to a mating member; and
a head continuing from the shank and having a regular-polygonal cross section, and
wherein the head has an expanding portion with a cross-sectional area gradually becoming larger toward the shank, and
an end portion, positioned nearer the shank, of the expanding portion has a periphery larger than a periphery of the shank.

9. The connector as set forth in claim 7 or claim 8, wherein
the expanding portion has convex surfaces.

10. The connector as set forth in claim 7, wherein
the reducing portion has convex surfaces.

11. The connector as set forth in claim 7 or claim 8, wherein
the expanding portion has flat planes.

12. The connector as set forth in claim 7, wherein
the reducing portion has flat planes.
